(19) United States
(12) Patent Application Publication
(10) Pub. No.: US 2016/0272133 A1
(43) Pub. Date: Sep. 22, 2016

(54) CURRENT REGULATOR FOR AN INDUCTIVE LOAD IN A VEHICLE

(71) Applicant: ROBERT BOSCH GMBH, Stuttgart (DE)

(72) Inventors: Steffen Reinhardt, Pforzheim (DE); Bernd Mueller, Reutlingen (DE)

(21) Appl. No.: 15/035,590

(22) PCT Filed: Sep. 29, 2014
(86) PCT No.: PCT/EP2014/070748

§ 371 Date: May 10, 2016

(30) Foreign Application Priority Data
Nov. 11, 2013 (DE) 102013222841.4

(51) Int. Cl. B60R 16/03; H02M 3/158

(52) U.S. Cl. CPC B60R 16/03; H02M 3/158

(57) ABSTRACT

The invention relates to a current regulator (1A) for an inductive load (Z_{L}) in a vehicle, comprising an analyzing and control unit (22); at least one circuit breaker (T2) which is looped-in serially to the inductive load (Z_{L}) and which is closed off from the magnetization of the inductive load (Z_{L}); a freewheel arrangement (10A) which causes a demagnetization of the inductive load (Z_{L}) when the circuit breaker (T2) is open; and a measuring device (24) which ascertains a current value of a current (I_{L}) flowing through the inductive load (Z_{L}). According to the invention, the freewheel arrangement (10A) comprises at least one switch (T_{F1}) which allows a switchover between at least two active freewheel voltages on the inductive load (Z_{L}), said analyzing and control unit (22) adjusting the current (I_{L}) flowing through the inductive load (Z_{L}) by means of control signals (GHS, GLS) on the basis of a change of a specified target value, said control signals being applied to the at least one circuit breaker (T2) and the at least one switch (T_{F1}) of the freewheel arrangement (10A).

### BACKGROUND OF THE INVENTION

The invention relates to a current regulator for an inductive load in a vehicle.

In the case of current regulators known from the prior art, a diode is used in the simplest case as a freewheel for an inductive load. If the freewheel voltage is to be reduced, a field-effect transistor can instead be used as the coupled diode. The time for the duration of the demagnetization is substantially determined by the effective extinction voltage or, respectively, freewheeling voltage. In this context, it is understood that the lower this voltage is, the longer the process lasts. In order to achieve a faster reduction of the energy in the inductance and thus more dynamic systems, an active clamp is used if applicable. In so doing, the coupled end stage is typically provided with an additional string. In the example of a low-side regulator, this means that the end stage for the magnetization of the inductive load is connected to ground; thus enabling the battery voltage to be applied to the inductive load. In order to demagnetize the inductive load, the end stage is switched off and the voltage at the output increases until reaching the adjusted clamp voltage. At this voltage, the end stage then becomes conductive due to the adjusted clamp voltage and maintains the voltage as long as current flows. It can thereby be considered disadvantageous that the freewheel voltage is dependent on the battery voltage. That means that the higher the battery voltage is, the lower the resulting freewheel voltage is. In the case of low battery voltage, a very high freewheel voltage results and thus possibly a demagnetization which is faster than desired.

A demagnetization can also alternatively take place via a resistor, which, however, leads to demagnetization times that are very much dependent on current. The high power loss in the extinction element, which occurs locally, can be considered a further disadvantage of the aforementioned methods. Particularly in PWM applications, additional measures for the purpose of cooling are required.

A circuit arrangement for the rapid switching of an inductive load is, for example, described in the German patent specification DE 10 2005 027 442 B4. The circuit arrangement comprises at least one high-side switch, which is disposed by means of a controlled path thereof in series with the load and between a first supply connection having a first supply potential and a second supply connection having a second supply potential which is lower in relation to the first supply potential, at least one freewheel diode, which is disposed at a first tap provided between the high-side switch and the load, and at least one clamping circuit designed as a limiter diode, which is connected between the one control connection of the high-side switch and the second supply connection and is designed to clamp the control potential applied to the control connection to a predetermined potential value when the high-side switch is switched off.

### SUMMARY OF THE INVENTION

The inventive sensor unit for a vehicle according to the invention has in contrast the advantage that a switchover can be made between an increased and a “normal” freewheel voltage. As a result, embodiments of the present invention dynamically control the current through the inductive load on the basis of the knowledge of a change in the specified target value by the system switching between the increased and non-increased or, respectively, normal freewheel voltage depending on the situation. That means that, as a function of the change in the specified target value or, respectively, in the current specified target value, the increased or the non-increased, respectively freewheel voltage, is used for the demagnetization of the inductive load. In order to achieve higher dynamics, the freewheel voltages differ significantly from one another. Embodiments of the current regulator according to the invention advantageously allow the power loss in the entire system to be optimized because the freewheel voltage is switched if necessary according to the specification of an analyzing and control unit which is based on a change in the specified target value; and a required demagnetization of the inductive load can be adapted.

Embodiments of the present invention provide a current regulator for an inductive load in a vehicle, comprising analyzing and control unit; at least one circuit breaker which is looped-in serially to the inductive load and which is closed for the magnetization of the inductive load; a freewheel arrangement which causes a demagnetization of the inductive load when the circuit breaker is open; and a measuring device which ascertains a current value of a current flowing through the inductive load. According to the invention, the freewheel arrangement comprises at least one switch which allows a switchover between at least two active freewheel voltages on the inductive load, said analyzing and control unit adjusting the current flowing through the inductive load by means of control signals on the basis of a change of a specified target value, said control signals being applied to the at least one circuit breaker and the at least one switch of the freewheel arrangement.

Embodiments of the current regulator according to the invention allow, for example, an increase in the freewheel voltage to occur which is independent of the battery voltage or an increase in the freewheel voltage to occur which is proportional to the battery voltage. The freewheel of the inductive load takes place, for example, by means of a clamping diode, the clamping voltage of which is greater than a forward voltage of a diode and which is designed as a Zener diode, to which a switch is arranged in parallel. The freewheel of the inductive load alternatively takes place via a switch, with which the voltage across the switch can be defined by means of additional ohmic resistors. As a further alternative, the freewheel can be implemented via two diodes, a first diode being connected to a first supply voltage and a second diode to a second supply voltage, wherein two circuit breakers are disposed in series to the inductive load and are closed for the magnetization of the inductive load. As a further alternative, the freewheel can be implemented via a diode against the first supply voltage when the voltage at the other connection of the inductive load is simultaneously switched over.

Common to all of the solutions is that a current flow through the inductive load is regulated. To this end, at least one circuit breaker is closed at regular intervals, which is disposed in series with the inductive load; thus enabling a voltage across the inductive load to become active, which in turn leads to a magnetization of the inductive load. If the at least one circuit breaker is open, the inductive load is demagnetized. In the process, the current flow through the inductive load is continually measured. The current flow can, for example, be ascertained by means of a voltage measured at a measuring resistor. The opening and closing of the at least one circuit breaker can occur in accordance with different specifications by the analyzing and control unit. Hence, a regulation at a constant frequency and with a variable duty cycle is just as possible as a regulation in which the respective circuit breaker is switched on for a constant time period and a switch-off time of the circuit breaker is varied, or in which the respective circuit breaker is switched off for a constant period of time and a switch-on time of the circuit breaker is varied.

It is particularly advantageous that a first circuit breaker can, for example, be a high-side switch which connects the inductive load for magnetization to a first supply voltage, preferably to a positive voltage. A second circuit breaker can, for example, be a low-side switch which connects the inductive load for magnetization to a second supply voltage, preferably to a ground voltage. The first circuit breaker can, for example, be embodied as a PMOS-FET. The second circuit breaker can, for example, be embodied as a NMOS-FET.

In an advantageous embodiment of the current regulator according to the invention, a first freewheel arrangement connected in parallel to the inductive load can comprise a clamping diode, which has a predetermined clamping voltage, and a first switch connected in parallel to the clamping diode. In so doing, a first freewheel voltage appears on the inductive load when the first switch is open, said voltage being higher than a second freewheel voltage, which appears on the inductive load when the first switch is closed, approximately by the amount of the predetermined clamping voltage.

In an alternative embodiment of the current regulator according to the invention, a second freewheel arrangement can comprise a first switch connected in parallel to the load and two ohmic resistors. In this case, a first resistor is looped-into an activation current path, which connects a control connection of the first switch to a corresponding control signal; and a second resistor connects a first output connection of the first switch, which is connected to the inductive load, to the control connection of the first switch. In so doing, a freewheel voltage, which is dependent on the control signal, appears on the inductive load when the first switch is open.

In a further advantageous embodiment of the current regulator according to the invention, a diode can be looped-in serially to the first or second freewheel arrangement, said diode preventing a current flow through the first or second freewheel arrangement during the magnetization of the inductive load.

In a further advantageous embodiment of the current regulator according to the invention, a first circuit breaker can connect the inductive load to a first supply voltage; and a second circuit breaker can connect the inductive load to a second supply voltage, wherein the analyzing and control unit closes both circuit breakers for the magnetization of the inductive load.

In a further advantageous embodiment of the current regulator according to the invention, a third freewheel arrangement can comprise a first freewheel diode, which connects a terminal of the inductive load to the first supply voltage, and a second freewheel diode, which connects another terminal of the inductive load to the second supply voltage, wherein a first freewheel voltage appears on the inductive load when the first and second circuit breaker are open, said freewheel voltage being higher than a second freewheel voltage which appears on the inductive load if either the first circuit breaker or the second circuit breaker is closed. As a further alternative, a fourth freewheel arrangement can comprise a first freewheel diode, which connects a terminal of the inductive load to the first supply voltage, and a clamping diode, which connects another terminal of the inductive load to the first supply voltage. As a result, a first freewheel voltage appears on the inductive load when the first and second circuit breaker are open, said first freewheel voltage being higher than a second freewheel voltage which appears on the inductive load if the first circuit breaker is closed and the second circuit breaker is open.

In a further embodiment of the current regulator according to the invention, the first freewheel diode and/or the second freewheel diode can be embodied as a switch.

### BRIEF DESCRIPTION OF THE DRAWINGS

Exemplary embodiments of the invention are depicted in the drawings and are explained in greater detail in the following description. In the drawings, identical reference signs denote components or elements which carry out the same or analogous functions.

FIG. 1 shows a schematic block diagram of a first exemplary embodiment of an inventive current regulator for an inductive load in a vehicle.

FIG. 2 shows a schematic block diagram of a second exemplary embodiment of an inventive current regulator for an inductive load in a vehicle.

FIG. 3 shows a schematic block diagram of a third exemplary embodiment of an inventive current regulator for an inductive load in a vehicle.

FIG. 4 shows a schematic block diagram of a fourth exemplary embodiment of an inventive current regulator for an inductive load in a vehicle.

### DETAILED DESCRIPTION

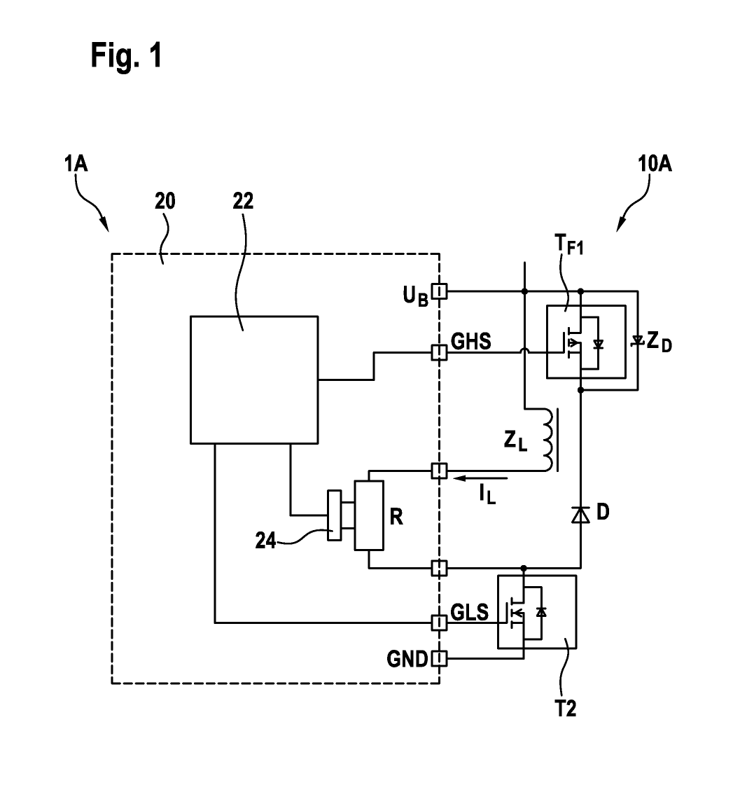

As can be seen in FIGS. 1 to 4, the depicted exemplary embodiments of an inventive current regulator 1A, 1B, 1C, 1D for an inductive load Z_{L} in a vehicle each comprise an analyzing and control unit 22; at least one circuit breaker T1 which is looped-in serially to the inductive load Z_{L} and which is closed for the magnetization of the said inductive load Z_{L}; a freewheel arrangement 10A, 10B, 10C, 10D which causes a demagnetization of the inductive load Z_{L} when the circuit breaker T1, T2 is open; and a measuring device 24 which ascertains a present current value of a current flow I_{L} through the inductive load Z_{L}. According to the invention, the freewheel arrangement 10A, 10B, 10C, 10D comprises at least one switch T_{F1}, T_{F2} which allows a switchover between at least two active freewheel voltages on the inductive load Z_{L}, said analyzing and control unit 22 adjusting the current I_{L} flowing through the inductive load Z_{L} by means of control signals GHS, GLS on the basis of a change in a specified target value, said control signals being applied to the at least one circuit breaker T1, T2 and the at least one switch T_{F1}, T_{F2} of the freewheel arrangement 10A, 10B, 10C, 10D.

As can further be seen in FIGS. 1 to 4, the current I_{L} flowing through the inductive load Z_{L} is regulated by the analyzing and control unit 22. To this end, the analyzing and control unit 22 closes the at least one circuit breaker T1, T2 at regular intervals via corresponding control signals GLS, GHS; thus enabling a voltage to become active over the inductive load, which leads to a magnetization of the inductive load Z_{L}. If the at least one circuit breaker T1, T2 is opened, the inductive load Z_{L} is then demagnetized. During the process, the current value of the present current I_{L} flowing through the inductive load Z_{L} is continually measured. This measuring process results, for example, from the fact that the measuring device 24 measures a voltage across a measuring resistor and the corresponding current value is calculated from the voltage. The opening and closing of the at least one circuit breaker T1, T2 can take place in accordance with different specifications by the analyzing and control unit 22. On the basis of a change in the specified target value, a regulation at a constant frequency and with a variable duty cycle is therefore just as possible as a regulation in which the respective circuit breaker T1, T2 is switched on for a constant period of time and a switch-off time of the circuit breaker T1, T2 is varied or in which the respective circuit breaker T1, T2 is switched off for a constant period of time and a switch-on time of the circuit breaker T1, T2 is varied.

As can further be seen in FIGS. 1 to 4, the analyzing and control unit 22 and the measuring device 24, comprising the corresponding measuring resistor R, are integrated into an ASIC 20 (application-specific integrated circuit) in the exemplary embodiments depicted; and the individual components, such as, for example, switches and/or diodes and/or Z-diodes, of the different freewheel arrangements 10A, 10B, 10C, 10D are disposed outside of the ASIC 20. It is however also possible to place the measuring resistor outside of the ASIC just as it is possible to integrate the components of the freewheel arrangements 10A, 10B, 10C, 10D into the ASIC 20. All of the exemplary embodiments depicted using the example of a low-side regulator of a transmission control in a vehicle can correspondingly be applied to a high-side regulator of a transmission control.

As can further be seen in FIG. 1, a circuit breaker T2 designed as a low-side switch is connected in series to the inductive load Z_{L} in the first exemplary embodiment depicted of an inventive current regulator IA for an inductive load Z_{L} in a vehicle. The circuit breaker T2 is designed as a NMOS-FET and connects the inductive load Z_{L} for magnetization to a second supply voltage GND, which corresponds to a ground potential in the exemplary embodiment depicted. A first freewheel arrangement 10A connected in parallel to the inductive load Z_{L} comprises a clamping diode Z_{D} having a predetermined clamping voltage and a first switch T_{F1} connected in parallel to the clamping diode Z_{D}. When the first switch T_{F1} is open, a first freewheel voltage appears on the inductive load Z_{L}, which is higher than a second freewheel voltage, which appears on the inductive load Z_{L} when the first switch T_{F1} is closed, approximately by amount of the predetermined clamping voltage of the clamping diode Z_{D}. In the exemplary embodiment depicted, the clamping diode Z_{D} is designed as a Zener diode, the breakdown voltage of which is higher than a forward voltage of a normal diode. In the exemplary embodiment depicted, the first switch T_{F1} is designed as a PMOS-FET and is thus connected in parallel to the clamping diode Z_{D} such that said first switch, in the switched-on state, absorbs the current and only the voltage across the first switch T_{F1} represents an input to the freewheel voltage; whereas, in the switched-off state, the first switch T_{F1} blocks during freewheel and the freewheel current flows entirely through the clamping diode Z_{D}. Hence, the current during freewheel flows either through the first switch T_{F1} or through the clamping diode Z_{D} to the first supply voltage U_{B} of a vehicle battery, which corresponds to a positive voltage potential, so that the freewheel voltage applied across the inductive load Z_{L} is not dependent on the first supply voltage U_{B}. A diode connected in series to the parallel circuit consisting of the first switch T_{F1} and the clamping diode Z_{D} prevents a current flow across the clamping diode Z_{D} or a parasitic diode of the first switch T_{F1} if the circuit breaker T2 is conductively connected.

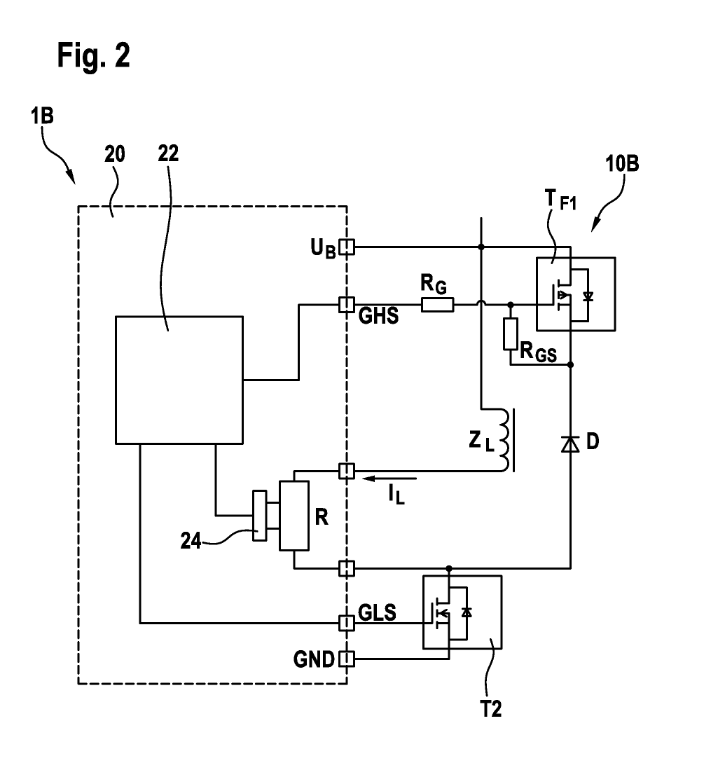

As can further be seen in FIG. 2, a circuit breaker T2 designed as a low-side switch is connected in series to the inductive load Z_{L} in the depicted second exemplary embodiment of an inventive current regulator 1B for an inductive load Z_{L} in a vehicle. Analogous to the first exemplary embodiment, the circuit breaker T2 is designed as a NMOS-FET and connects the inductive load Z_{L} for magnetization to the second supply voltage GND, which corresponds to the ground potential. A second freewheel arrangement 10B comprises a first switch T_{F1} connected in parallel to the inductive load Z_{L} and two ohmic resistors R_{G}, R_{GS}. Analogous to the first exemplary embodiment, the first switch T_{F1} is also designed as a PMOS-FET. A first resistor R_{G} is looped-into the control current path which connects a control terminal G of the first switch T_{F1} to a corresponding control signal GHS. A second resistor R_{GS} connects a first output terminal S of the first switch T_{F1} to a corresponding control signal GHS. A second resistor R_{GS} connects a first output terminal S of the first switch T_{F1}, which is connected to the load Z_{L}, to the control connection G of the first switch T_{F1}, a freewheel voltage appearing on the inductive load Z_{L}, which voltage is dependent on the control signal GHS, when the first switch T_{F1} is open. The PMOS-FET used here as the first switch T_{F1} becomes conductive if the amount of the source gate voltage Vth exceeds a certain threshold value. This always occurs in the freewheel mode, in which the current through the switch T_{F1} designed as a PMOS-FET flows from a source connection S to a drain connection D; because, on the one hand, the current is applied to the inductive load Z_{L} and, on the other hand, a backward diode of the switch T_{F1} designed as PMOS-FET is reverse biased in the selected arrangement. The voltage Vth drops across the second resistor R_{GS}. The current which thereby flows through the second resistor R_{GS} also flows through the first resistor R_{G}; thus enabling the voltage at the source connection S to be determined by the amplitude of the control signal GHS and the voltage across the resistors R_{GS} and R_{G}. Analogous to the first exemplary embodiment, the diode D connected in series to the source terminal S prevents current from flowing across the resistors R_{GS} and R_{G} or the parasitic diode of the first switch T_{F1} if the circuit breaker T2 is conductively connected. If the amplitude of the control signal GHS corresponds to the first supply voltage U_{B}, the freewheel voltage, which is applied to the inductive load Z_{L}, is independent of the first supply voltage U_{B} as well as greater than a diode forward voltage. If the amplitude of the control signal GHS is lower than the first supply voltage U_{B}, a lower freewheel voltage appears on the inductive load Z_{L}.

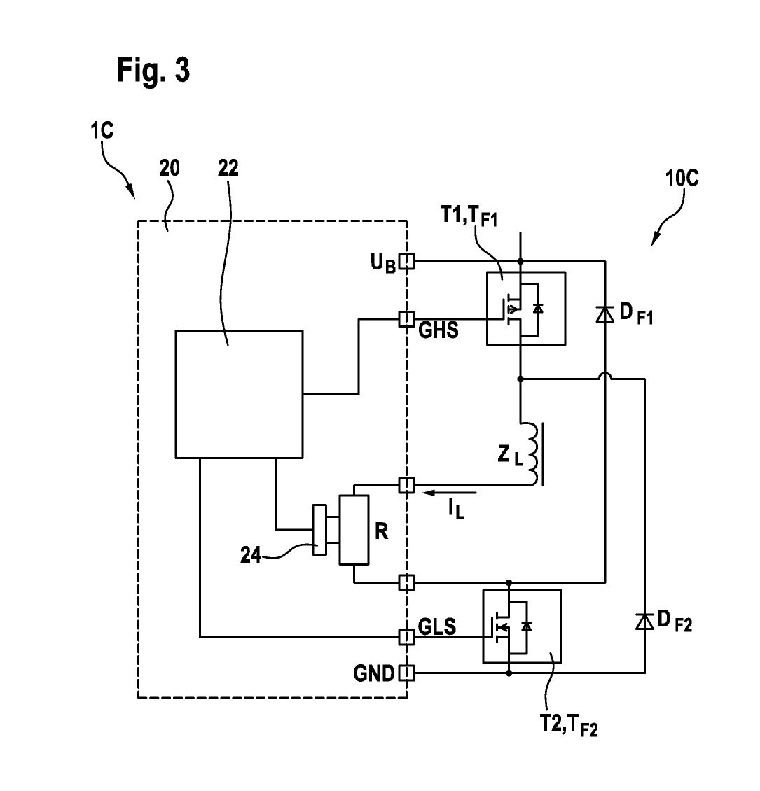

As can additionally be seen in FIG. 3, a first circuit breaker T1 designed as a high-side switch and a second circuit breaker T2 designed as a low-side switch are connected in series to the inductive load Z_{L} in the third depicted exemplary embodiment of a current regulator 1C according to the invention for an inductive load Z_{L} in a vehicle. The first circuit breaker T1 is designed as a PMOS-FET and connects the inductive load Z_{L} to the first supply voltage U_{B}. The second circuit breaker T2 is designed as an NMOS-FET and connects the inductive load Z_{L} to the second supply voltage GND. In order to magnetize the inductive load Z_{L} the analyzing and control unit 22 closes both circuit breakers T1, T2 via the control signals GLS, GHS. A third freewheel arrangement 10C comprises a first freewheel diode D_{F1}, which connects a terminal of the inductive load Z_{L} to the first supply voltage U_{B}, and a second freewheel diode D_{F2} which connects another terminal of the inductive load Z_{L} to the second supply voltage GND. When the first and second circuit breaker T1, T2 are open, a first freewheel voltage appears on the inductive load Z_{L} which is higher than a second freewheel voltage which appears on the inductive load Z_{L} if either the first circuit breaker T1 or the second circuit breaker T2 is closed. The two circuit breakers T1, T2 therefore also act as a first or, respectively, second switch T_{F1} or T_{F2} of the third freewheel arrangement 10C, which allows a switchover between the different freewheel voltages. In the third freewheel arrangement 10C depicted in the drawings, the freewheel voltage applied to the inductive load Z_{L} is greater than the first supply voltage U_{B} by two diode forward voltages. A very large freewheel voltage, which is even greater than the voltage for magnetization of the inductive load Z_{L}, therefore results. The advantage of this solution in comparison to active clamps is that the freewheel voltage behaves proportionally to the supply voltage U_{B} so that there is only a small amount of dependency of the duty cycle on the first supply voltage in regulated systems. In addition, the energy of the inductive load Z_{L} is advantageously reduced substantially by means of the supply voltage and not by means of the freewheel circuit. The third freewheel arrangement 10C can even be varied to the effect that the two freewheel diodes D_{F1}, D_{F2} are replaced by switches which are actuated by the analyzing and control unit 22 in antiphase to the circuit breakers T1, T2. As a result, the power loss in the discrete components can be reduced in an advantageous manner.

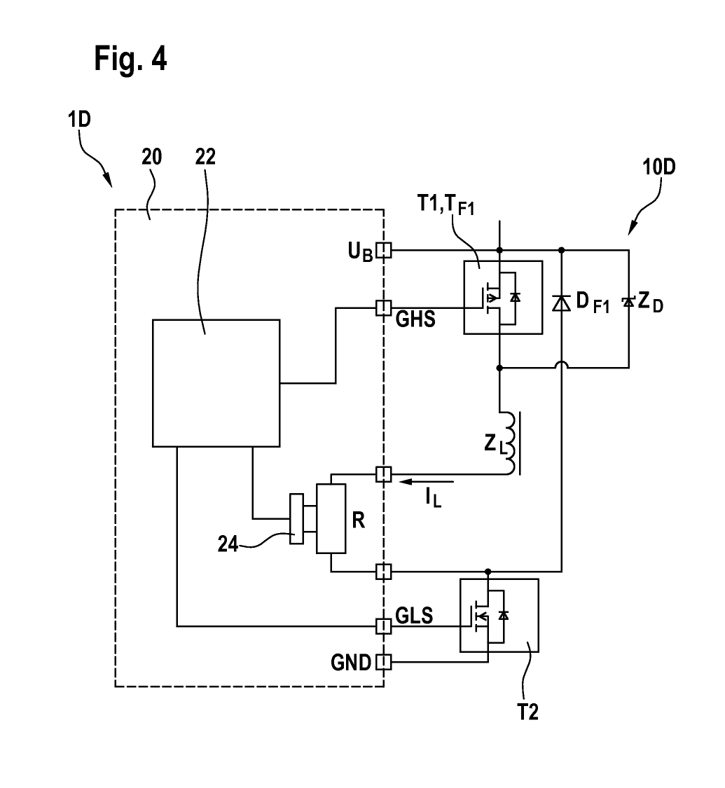

As can further be seen in FIG. 4, a first circuit breaker T1 designed as a high-side switch and a second circuit breaker T2 designed as a low-side switch are connected in series to the inductive load Z_{L} in the fourth depicted exemplary embodiment of a current regulator 1D according to the invention for an inductive load Z_{L} in a vehicle. Analogous to the third exemplary embodiment, the first circuit breaker T1 is designed as a PMOS-FET and connects the inductive load Z_{L} to the first supply voltage U_{B}. The second circuit breaker T2 is designed as a NMOS-FET and connects the inductive load Z_{L} to the second supply voltage GND. In order to magnetize the inductive load Z_{L}, the analyzing and control unit 22 closes both circuit breakers T1, T2 via the control signals GLS, GHS. A fourth freewheel arrangement 10D comprises a freewheel diode D_{F1}, which connects a terminal of the inductive load Z_{L} to the first supply voltage U_{B}, and a clamping diode Z_{D}, which connects another terminal of the inductive load Z_{L} to the first supply voltage U_{B}. When the first and second circuit breaker T1, T2 are open, a first freewheel voltage appears on the inductive load Z_{L} which is higher than a second freewheel voltage which appears on the inductive load Z_{L} if the first circuit breaker T1 is closed and the second circuit breaker T2 is open. In the case of the fourth freewheel arrangement 10D, the freewheel takes place via the freewheel diode D_{F1} against the first supply voltage U_{B}. In order to increase the freewheel voltage, the other terminal of the inductive load Z_{L} can simultaneously be switched over via the first circuit breaker T1, which operates as the switch T_{F1} of the fourth freewheel arrangement. As a rule, this connection of the inductive load Z_{L} is fixedly connected to the first supply voltage or, respectively, to a battery contact. If this terminal of the inductive load Z_{L} is connected to the battery via the switch T_{F1}, the freewheel voltage is then unchangingly approximately a diode forward voltage when the switch is closed. In order to increase the freewheel voltage, the switch T_{F1} can be switched open, i.e. in a high ohmic manner. The current then flows over the clamping diode Z_{D}, which, for example, is designed as a Zener diode or as another element having high voltage; and the freewheel voltage is increased by the clamping voltage.

Embodiments of the current regulator according to the invention for an inductive load can, for example, be used for a transmission control system in a vehicle.

1. A current regulator for an inductive load in a vehicle, comprising:
an analyzing and control unit;
at least one circuit breaker which is looped-in serially to the inductive load and which is closed for the magnetization of the inductive load;
a freewheel arrangement which causes a demagnetization of the inductive load when the circuit breaker is open; and
a measuring device which ascertains a current value of a current flowing through the inductive load, wherein the freewheel arrangement comprises at least one switch which allows a switchover between at least two active freewheel voltages on the inductive load, said analyzing and control unit adjusting the current flowing through the inductive load by means of control signals on the basis of a change of a specified target value, said control signals being applied to the at least one circuit breaker and the at least one switch of the freewheel arrangement.

2. The current regulator according to claim 1, wherein a first circuit breaker is a high-side switch which connects the inductive load for magnetization to a first supply voltage.

3. The current regulator according to claim 1, wherein a first second circuit breaker is a low-side switch which connects the inductive load for magnetization to a second supply voltage.

4. The current regulator according to claim 1, wherein a first freewheel arrangement which is connected in parallel to the inductive load comprises a clamping diode, which has a predetermined clamping voltage, and a first switch connected in parallel to the clamping diode, wherein a first freewheel voltage on the inductive load appears when the first switch is open, said first freewheel voltage being higher than a second freewheel voltage which appears on the inductive load approximately by the amount of the predetermined clamping voltage of the clamping diode when the first switch is closed.

5. The current regulator according to claim 1, wherein a second freewheel arrangement comprises a first switch connected in parallel to the inductive load and two ohmic resistors, wherein a first resistor is looped-into a control current path, which connects a control terminal of the first switch to a corresponding control signal, and wherein a second resistor connects a first output terminal of the first switch, which is connected to the inductive load, to the control terminal of the first switch, a freewheel voltage appearing on the inductive load, which is dependent on the control signal, when the first switch is open.

6. The current regulator according to claim 4, wherein a diode is looped-in serially to the first or second freewheel arrangement, said diode preventing current from flowing through the first or second freewheel arrangement during the magnetization of the inductive load.

7. The current regulator according to claim 1, wherein a first circuit breaker connects the inductive load to a first supply voltage and a second circuit breaker connects the inductive load to a second supply voltage, wherein the analyzing and control unit closes both circuit breakers for the magnetization of the inductive load.

8. The current regulator according to claim 7, wherein a third freewheel arrangement comprises a first freewheel diode, which connects a terminal of the inductive load to the first supply voltage, and a second freewheel diode, which connects another terminal of the inductive load to the second supply voltage, wherein a first freewheel voltage on the inductive load appears when the first and second circuit breaker are open, said first freewheel voltage being higher than a second freewheel voltage, which appears on the inductive load if either the first circuit breaker or the second circuit breaker is closed.

9. The current regulator according to claim 7, wherein a fourth freewheel arrangement comprises a first freewheel diode, which connects a terminal of the inductive load to the first supply voltage, and a clamping diode, which connects another terminal of the inductive load to the first supply voltage, wherein a first freewheel voltage appears on the inductive load when the first and second circuit breaker are open, said first freewheel voltage being higher than a second freewheel voltage, which appears on the inductive load if the first circuit breaker is closed and the second circuit breaker is open.

10. The current regulator according to claim 8, wherein the first freewheel diode, the second freewheel diode, or both are designed as switches.
